(19) United States
(12) Patent Application Publication
(10) Pub. No.: US 2015/0033625 A1
(43) Pub. Date: Feb. 5, 2015

(54) Sub-Irrigated Planter

(71) Applicants: Christopher J. Jawarski, Union, MI (US); Robin L. Jaworski, Union, MI (US)

(72) Inventors: Christopher J. Jawarski, Union, MI (US); Robin L. Jaworski, Union, MI (US)

(21) Appl. No.: 13/957,459

(22) Filed: Aug. 2, 2013

(51) Int. Cl. A01G 9/02

(52) U.S. Cl. CPC A01G 9/02
USPC 47/79

(57) ABSTRACT

The sub-irrigated planter includes a basin; a removable basin lid, a removable wick and a fabric potting bag. The basin and basin lid provide an enclosed water storage vessel for the planter. The wick provides the structural platform for supporting the soil and plants grown in the potting bag and acts as an irrigation conduit for the soil in the potting bag. The potting bag is constructed of a non-wicking but air permeable fabric, which prevents water from wicking up the sidewall of the bag, but still allows air to pass through the sidewall into the soil.

### This invention relates to planters for container gardening, and in particular, a sub-irrigated planter.

### BACKGROUND AND SUMMARY OF THE INVENTION “Sub-irrigated planter” (SIP) is a generic name for a type of planting box used in container gardening and commercial landscaping. Sub-irrigating planter refers to planters that introduce water from the bottom of the planter, allowing the water to soak upwards to the plant through capillary action. Sub-irrigated planters typically include a water reservoir basin and a perforated terracotta or plastic planter pot seated within the basin. Sub-irrigated planters can be readily adapted for use with automated irrigation systems, which makes them popular with professional greenhouses.

The present invention seeks to provide an improved sub-irrigated planter, which includes a basin; a removable basin lid, a removable wick and a fabric potting bag. The basin and basin lid provide an enclosed water storage vessel for the planter. The wick provides the structural platform for supporting the soil and plants grown in the potting bag and acts as an irrigation conduit for the soil in the potting bag. The potting bag is constructed of a non-wicking but air permeable fabric, which prevents water from wicking up the sidewall of the bag, but still allows air to pass through the sidewall into the soil. The anti-wicking properties of potting bag fabric helps prevent mold, fungus, and other harmful micro-organisms from adhering to the bag sidewall, which can harm the plants. In addition, the air permeable properties of the potting bag fabric promotes root oxygenation and helps reduce the growth of fungus and other harmful microorganisms on the bag sidewalls.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective view of an embodiment of the planter of this invention;

FIG. 2 is an exploded view of the planter of FIG. 1:

FIG. 3 is another exploded view of the planter of FIG. 1;

FIG. 4 is a perspective view of the planter of FIG. 1 with a portion of the basin, lid and potting bag cut away; and

FIG. 5 is a side sectional view of the planter of FIG. 1.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

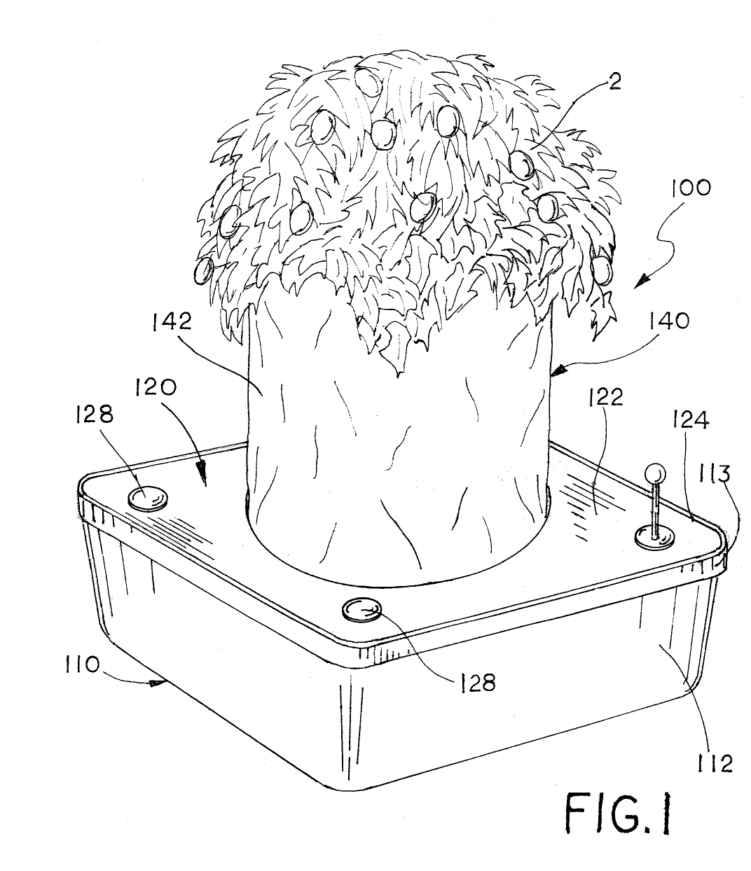

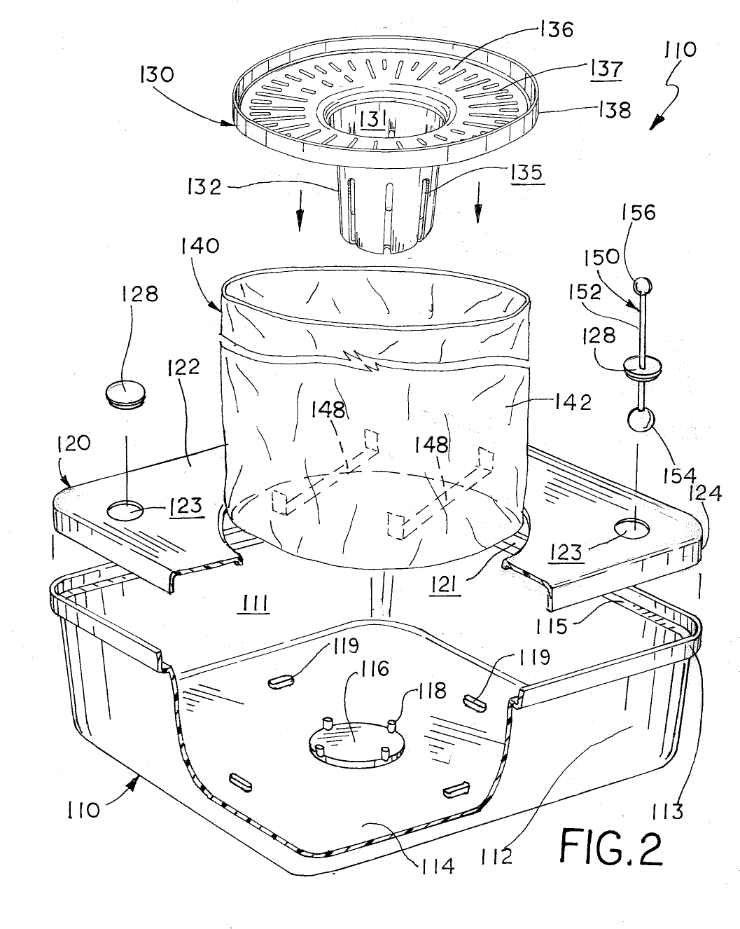

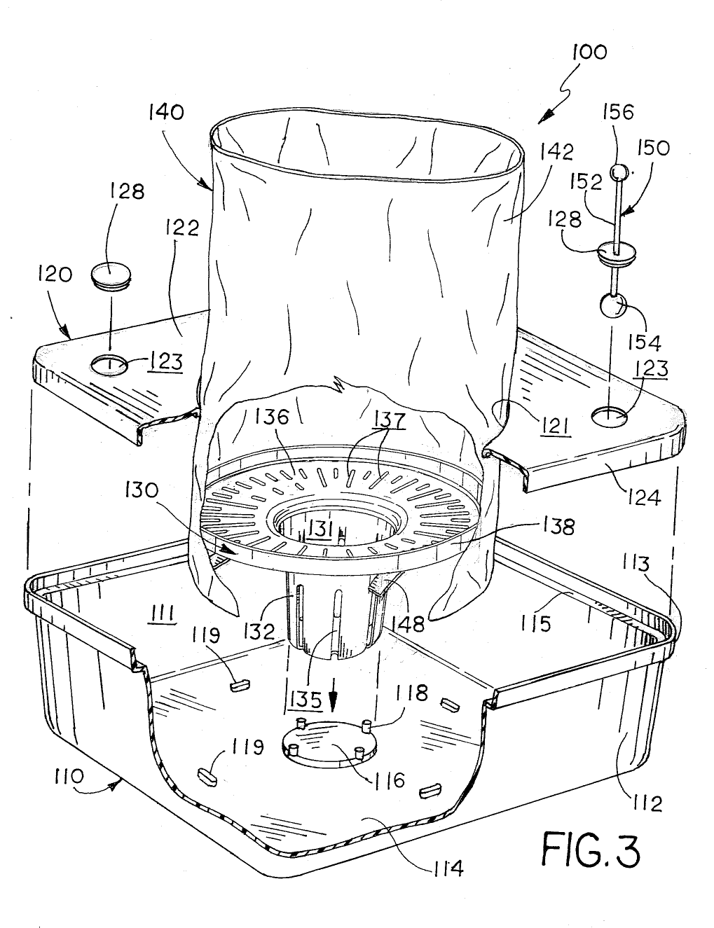

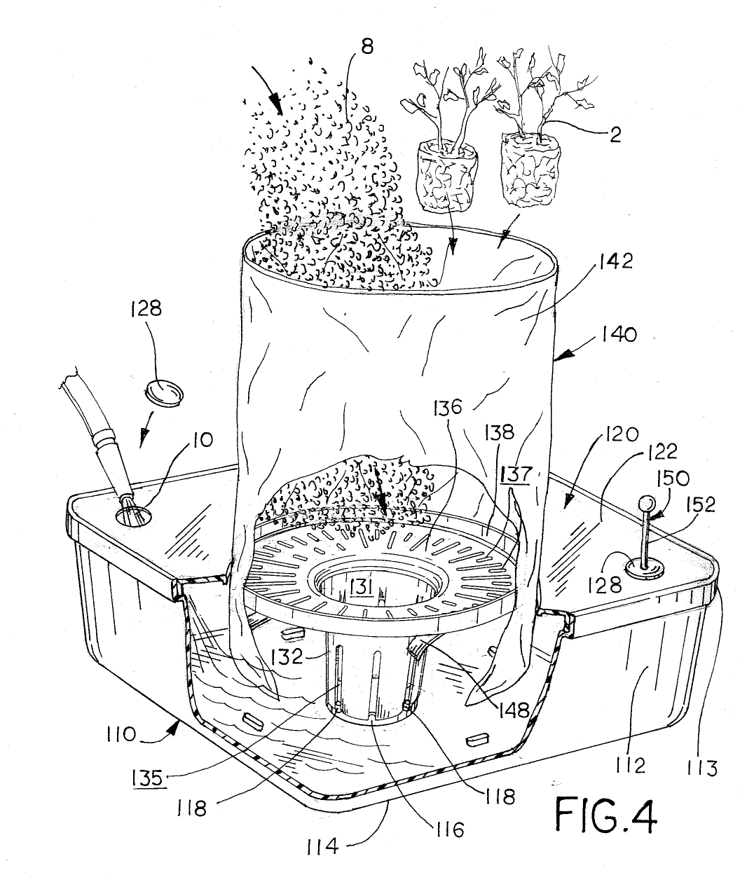

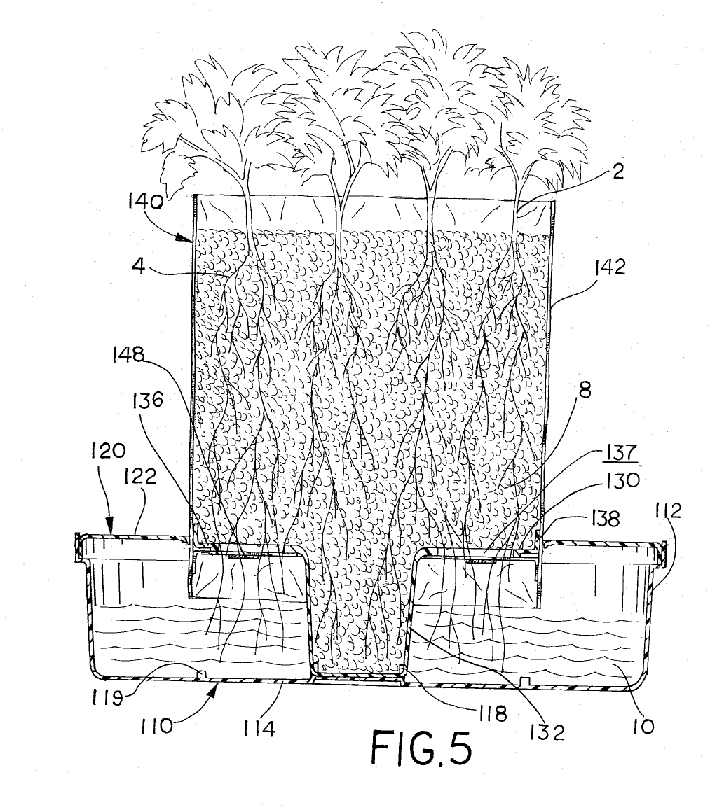

Referring now to the drawings, FIGS. 1-5 illustrate an embodiment of a sub-irrigated planter of this invention, which is designated generally as reference numeral 100. Planter 100 is design for both residential and commercial use in growing living plants. Planter 100 includes four basic components: a reservoir basin 110; a removable basin lid 120, a removable wick 130 and a fabric potting bag 140.

Basin 110 and basin lid 120 provided an enclosed water storage vessel for planter 100. Reservoir basin 110 and basin lid 120 are typically formed or molded of a suitable plastic material, but may be constructed of any suitable materials as desired. As shown, basin 110 and lid 120 have a square configuration, but their shape and physical dimensions may vary as desired. Lid 120 is configured and dimensioned to enclose the open top of basin 110. Basin 110 has an open reservoir interior 111 defined by four sidewalls 112 and an integral bottom 114. The top edge of sidewalls 112 terminate in a peripheral joggled lip 113 that forms an inset inner shoulder 115. An integral raised circular wick seat 116 extends upward from basin bottom 114. Four alignment posts 118 extend upward from the outside of wick seat 116. Basin bottom 114 also has four radially spaced packing ridges 119, which allow wick 130 to be conveniently nested upside down within basin 110 for compact commercial packaging. Basin lid 120 is seated atop basin 110 enclosing basin interior 111. Basin lid 120 includes a flat top 122 and a down-turned peripheral rim 124 that nests against shoulder 115 when the lid is fitted to basin 110. Basin lid 120 has a large central opening 121 for receiving wick 130 and potting bag 140. Basin lid 140 also has four circular corner openings 123, which act as water fill ports. Removable plug caps 128 seat within opening 123, but can be removed when filling basin 110 with water.

Wick 130 provides the structural platform for supporting the soil and plants grown in the potting bag 140 and acts as an irrigation conduit for the soil in the potting bag. Like Basin 110 and basin lid 120, wick 130 is ideally formed or molded from a suitable plastic material, but may be constructed of any suitable materials as desired. Wick 130 is generally configured to have cylindrical well part 142 and an integral flat annular tray 136 that extends outward around the open mouth of the well part. Well part 132 is formed by a cylindrical sidewall and a flat bottom wall. The outer edge of wick tray 136 terminates in up-turned annular flange or rim 138. Wick well 132 and tray 136 each have a plurality of openings or slots formed therein, which allow water to be drawn into the soil deposited in the potting bag 140. As shown, a plurality of radial slots 137 are formed in wick tray 136 and a plurality of vertical slots 135 are formed in cylindrical well sidewalls, which extend inward radially in the flat bottom wall.

Potting bag 140 is constructed of a non-wicking but air permeable fabric, such as woven polyethylene. The fabric of potting bag 140 sidewall is selected so that water does not wick up the sidewall of the bag, but still allows air to pass through the sidewall into the soil. As shown, potting bag 140 is sewn using conventional construction techniques, hems and stitching. Potting bag 140 is sewn to have cylindrical bag sidewalls 142 defining the bag interior 141 with both an open top and bottom. A pair of stirrups 148 are sewn to sidewall 142 to traverse parallel the bag interior near the open bottom of potting bag 140.

In use, wick 130 is placed within potting bag 140 so that stirrups 148 underlie the bottom of wick tray 136 on either side of well sidewall 132. Both the wick 130 and potting bag 140 are seated within central opening 121 in basin lid 120. As shown, wick 130 is seated atop wick seat 116 with post 118 seated within slots 145 of well sidewall 144. When seated within basin 110 and basin lid 120, tray 142 is positioned at the mouth of central opening 142 so that well part 142 is disposed within basin interior 111. Sidewalls 142 of potting bag 140 sit upright from central opening 121. Soil 8 is deposited into planting bag 140 atop wick 130. The weight of the soil within potting bag 140 supports and hold the fabric bag sidewalls upright. Various seeds, seedlings and live plants 2 are planted in soil 8 within the potting bag and basin reservoir is filled with water 10 and other liquid nutrients through any of the openings 123 in basin lid 120. Water 10 is drawn through slots 135 of wick 130 and upward into soil 8 within potting bag 140 by capillary attraction. The anti-wicking fabric of potting bag 140 prevents the bag sidewall 142 from saturating with water, thereby reducing the opportunity for mold, fungus, and other harmful microorganisms from adhering to the potting bag, which can harm the plants. The air permeable fabric of potting bag 140 allows air to ready pass through sidewall 142 into the soil, which promotes root oxygenation and helps reduce the growth of fungus and other harmful microorganisms on the bag sidewalls. It should be noted that slots 135 and 137 are dimensioned so that soil generally does not fall through wick 130 into the basin interior. Plant roots may extends through slots 135 and 137, but generally small branching roots are “air pruned” from main roots that extending through slots 137 of tray 136.

Planter 100 also includes a water level indicator 150. Water level indicator 150 includes an elongated rod 152, a float bob 154 and a mark 156. As shown, rod 152 is reciprocally disposed within a bore in one of plugs 128, but in alternative embodiments may be disposed within a bore in the basin lid, itself. Float bob 154 and marker 156 are fixed to opposite ends of rod 152, so that float 154 extends into basin interior and floats atop the water in the basin. As the water level rises in the basin, float 154 elevates mark 156 above the plug 128, providing a visual indication of the water level.

### Advantages

One skilled in the art will note that the sub-irrigated planter of this invention provides several advantages over conventional planters. The planter has a compact design, that is configured to be conveniently used in both commercial greenhouses and residential applications. Multiple planters can be aligned in rows or clustered together in groups for convenient cultivation and irrigation. The fill ports in the basin lid allow the planters to be readily connected to automated irrigation systems. The planter is designed so that the separate components can be enclosed and stored within the reservoir basin and lid for convenient off-season storage and commercial packaging and display. The fabric potting bag neatly folds and stores within the well of the wick and the wick sits securely upside down within the basin with the lid enclosing the basin. With all components stowed within the basin, multiple planters can be stacked for convenient storage or commercial display. The reservoir basin provides a stable platform for the planter. The wick provides a structural platform for supporting the soil and plants grown in the potting bag, as well as a conduit for soil irrigation. The slots in the wick allow air to be drawn upward into the soil to nourish the plants. The slots are narrow enough to prevent any significant amount of soil from falling into the reservoir basin, but large enough to permit root growth through the wick into the basin interior. The non-wicking, but air permeable fabric of the potting bag allows direct air flow into the soil, which promotes accelerated plant growth and overall plant health, while preventing molds, fungus and other microorganisms from growing on the potting bag. The use of a fabric potting bag also reduces the overall weight of the planter.

It should be apparent from the foregoing that an invention having significant advantages has been provided. While the invention is shown in only a few of its forms, it is not just limited to the current form but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

We claim:

1. A planter for growing living plants in soil, the planter comprising:
a basin defining a basin interior therein for receiving water;
a potting bag constructed of a non-wicking and air permeable fabric and having a bag interior for receiving soil for growing the living plants and defined by a pliable cylindrical sidewall, the bag interior having an open top and open bottom thereof; and
a wick part adapted to sit within the bag interior and mount within the reservoir interior for supporting the potting bag over the basin and facilitating irrigation of the soil within the bag.

2. The planter of claim 1 and a removable lid adapted to connect to the basin to enclose the reservoir interior.

3. The planter of claim 2 wherein the lid includes an opening therein for filling the reservoir interior with water when the lid is connected to the basin.

4. The planter of claim 1 wherein the wick includes a well part defining a well interior having an open mouth and an integral annular tray extending radially outward from the well part around the well interior open mouth.

5. The planter of claim 4 wherein the well part and the annular tray each having a plurality of openings therein for communicating water from the basin interior into the soil deposited within the bag interior.

6. The planter of claim 5 wherein the basin includes a post extending into the basin interior, the post restrictively seated within one of the plurality of openings in the well part when the wick is mounted within the reservoir interior.

7. The planter of claim 1 wherein the basin includes a wick seat extending into the basin interior for supporting the wick when mounted within the basin interior.

8. The planter of claim 6 wherein the potting bag includes a stirrup part that extends traverse across the bag interior, the stirrup underlying the tray of the wick to secure the potting bag to the wick when the wick is mounted within the basin interior and supports the potting bag over the basin.

9. The planter of claim 2 and a water level indicator which includes a reciprocating rod extending upright through the lid and having one end disposed within the basin interior and an opposite end extending above the lid, a float mounted to the open end of the rod so that the float rests atop the water within the basin interior.

10. A planter for growing living plants in soil, the planter comprising:
a basin defining a basin interior therein for receiving water, the basin includes a post extending into basin interior, the basin includes a wick seat extending into the basin interior and a basin post;
a removable lid adapted to connect to the basin to encloses the reservoir interior, the lid includes an opening therein for filling the reservoir interior with water when the lid is connected to the basin;
a potting bag constructed of a non-wicking and air permeable fabric and having a bag interior for receiving soil for growing the living plants and defined by a pliable cylindrical sidewall, the bag interior having an open top and open bottom thereof, the potting bag includes a stirrup part that extends traverse across the bag interior; and
a wick part adapted to sit within the bag interior and mount within the reservoir interior for supporting the potting bag over the basin and facilitating irrigation of the soil within the bag, the wick includes a well part defining a well interior having an open mouth and an integral annular tray extending radially outward from the well part around the well interior open mouth, the well part and the annular tray each having a plurality of openings therein for communicating water from the basin interior into the soil deposited within the bag interior, the well part restrictively seated atop the basin seat with the basin post seated within one of the plurality of openings in the well part when the wick is mounted within the reservoir interior, the stirrup underlying the tray of the wick to secure the potting bag to the wick when the wick is mounted within the basin interior and to support the potting bag over the basin.
